(19) United States
(12) Patent Application Publication
(10) Pub. No.: US 2024/0296342 A1
(43) Pub. Date: Sep. 5, 2024

(54) Selection of Global Machine Learning Models for Collaborative Machine Learning in a Communication Network

(71) Applicant: Telefonaktiebolaget LM Ericsson (publ), Stockholm (SE)

(72) Inventors: Martin Isaksson, Stockholm (SE); Rickard Cöster, Hägersten (SE)

(21) Appl. No.: 18/567,618

(22) PCT Filed: Jun. 10, 2022
(86) PCT No.: PCT/SE2022/050571

§ 371 Date: Dec. 6, 2023

Related U.S. Application Data
(60) Provisional application No. 63/209,308, filed on Jun. 10, 2021.

(51) Int. Cl. G06N 3/098; G06N 3/0464

(52) U.S. Cl. CPC G06N 3/098; G06N 3/0464

(57) ABSTRACT

A computer-implemented method performed by a local computing device for collaborative machine learning in a communication network is provided. The method comprises receiving from a global computing device, a plurality of global ML models. The method further comprises evaluating a metric on a set of data of the local computing device for each respective global ML model from the plurality of global ML models. The evaluating comprises (i) generating a random number, and (ii) comparing the random number to a predetermined value. The method further comprises selecting a global ML model from the plurality of global ML models, wherein the selecting is (i) a random global ML model from the plurality of global ML models when the random number is less than the predetermined value, or (ii) a global ML model from the plurality of global ML models having a greatest performance on the set of data of the local computing device when the random number is greater than the predetermined value. The method further comprises transmitting the selected global ML model, or a gradient of the local computing device from the selected global ML model to the global computing device.

### TECHNICAL FIELD

The invention relates to selection of global machine learning models for collaborative machine learning (ML). The invention relates to a method and computing devices for selection of global machine learning models for collaborative machine learning in a communication network.

### BACKGROUND

Independent and Identically Distributed (IID) data includes data of independent events (e.g., data that is not connected to each other), and that lacks overall trends (e.g., a data distribution does not fluctuate, and the data are taken from the same probability distribution). In many real-world distributed applications, data that is generated on the edge of a network is non-Independent and Identically Distributed (non-IID), for example data generated in mobile phones, Internet of Things (IoT) devices, and radio base stations can have differences in data between clients and groups of clients. As used herein, a “client” refers to a local computing device (e.g., a user equipment (UE), a communication device, a mobile phone, an IoT device, a radio base station, a computer, etc.). Unless otherwise noted, the term “client” may be used interchangeably hereon with “local computing device”.

Federated Learning (FL) is a decentralized approach to ML where clients collectively train a global ML model without the need to share potentially sensitive private data. Such a FL approach avoids central collection of data and instead performs training of a ML model locally where the data is generated. The local ML model updates generated by clients, such as radio base stations, are then aggregated by parameter server or global computing device into a new global ML model. Unless otherwise noted, the term “server” or “parameter server” may be used interchangeably hereon with “global computing device”.

There currently exist certain challenge(s). In a decentralized setting it can be common to have non-IID data. This data can be of non-identical client distributions, which can be further characterized as:
Feature distribution skew (covariate-shift) where feature distributions is different between clients, so that the marginal distributions P (x) varies, but P (y|x) is shared, where P is probability, x is features of a data sample, and y is target of a data sample.
Label distribution skew (prior probability shift, or class imbalance) where the distribution of class labels varies between clients, so that P (y) varies but P (x|y) is shared.
Same label, different features (concept shift) where the conditional distributions P (x|y) varies between clients, but P (y) is shared.
Same features, different label (concept shift) where the conditional distributions P (y|x) varies between clients, but P (x) is shared.
Quantity skew (unbalancedness), where clients have different amounts of data.

Furthermore, the data independence between clients can be violated, and often is.

In many non-IID settings wherein there are multiple ML models needed, ML processes (such as algorithms) may fail to produce useable global ML models that are useable as expert models in a Mixture of Experts (MoE). A MoE refers to a combination of ML models, such as a local client ML model and global ML models (e.g., global FL models) as discussed further below with reference to FIG. 2. Additional potential problems of current approaches FL wherein there are multiple ML models are used, such as Iterative Federated Clustering Algorithm (IFCA), when data is non-IID may include that a client does not make a best or better selection of a global ML model, performance of the selected global ML model that is not acceptable or not optimal (e.g., convergence is slow, a lack of convergence, etc.). As a consequence, there is a need for handling non-IID data distribution among distributed clients to improve or optimize performance of ML models, improve convergence, and for priming ML models so clients can make improved estimates of cluster identity.

### SUMMARY

It is an object of embodiments herein to address at least some of the limitations, problems and issues outlined above. More specifically, it is an object of the disclosure to provide methods and computing devices for selection of global machine learning models for collaborative machine learning in a communication network.

These and other objects of embodiments herein are achieved by means of different aspects of the disclosure, as defined by the independent claims. Embodiments of the disclosure are characterized by the dependent claims.

According to a first aspect of embodiments herein, a computer-implemented method performed by a local computing device for collaborative machine learning in a communication network is provided. The method comprises receiving from a global computing device, a plurality of global ML models. The method further comprises evaluating a metric on a set of data of the local computing device for each respective global ML model from the plurality of global ML models. The evaluating comprises (i) generating a random number, and (ii) comparing the random number to a predetermined value. The method further comprises selecting a global ML model from the plurality of global ML models, wherein the selecting is (i) a random global ML model from the plurality of global ML models when the random number is less than the predetermined value, or (ii) a global ML model from the plurality of global ML models having a greatest performance on the set of data of the local computing device when the random number is greater than the predetermined value. The method further comprises transmitting the selected global ML model, or a gradient of the local computing device from the selected global ML model to the global computing device.

According to a second aspect of embodiments herein, a computer-implemented method performed by a global computing device for collaborative machine learning (ML) in a communication network is provided. The method comprises initializing and training, a plurality of global ML models. The method further comprises selecting a set of local computing devices from a plurality of computing devices. The method further comprises transmitting to each of the corresponding local computing device of the identified set of local computing devices, the plurality of global ML models. The method further comprises receiving from each of the corresponding local computing device of the identified set of local computing devices either a selected ML model, or a gradient of the corresponding local computing device. The method further comprises training the plurality of global ML models using the selected ML model, or the gradient of the corresponding local computing device received from each of the corresponding local computing device of the identified set of local computing devices.

According to a third aspect of embodiments herein, a local computing device for collaborative machine learning in a communication network is provided. The local computing device includes at least one processor and at least one memory connected to the at least one processor and storing program code that is executed by the at least one processor to perform operations comprising the following. The operations comprise receive from a global computing device, a plurality of global ML models. The operations further comprise evaluate a metric on a set of data of the local computing device for each respective global ML model from the plurality of global ML models. The evaluate comprises (i) generating a random number, and (ii) comparing the random number to a predetermined value. The operations further include select a global ML model from the plurality of global ML models. The select is (i) a random global ML model from the plurality of global ML models when the random number is less than the predetermined value, or (ii) a global ML model from the plurality of global ML models having a greatest performance on the set of data of the local computing device when the random number is greater than the predetermined value. The operations further comprise transmit the selected global ML model, or a gradient of the local computing device from the selected global ML model to the global computing device.

According to a fourth aspect of embodiments herein, a global computing device for collaborative machine learning in a communication network is provided. The global computing device includes at least one processor and at least one memory connected to the at least one processor and storing program code that is executed by the at least one processor to perform operations comprising the following. The operations comprise initialize and train, a plurality of global ML models. The operations further comprise select a set of local computing devices from a plurality of computing devices. The operations further comprise transmit to each of the corresponding local computing device of the identified set of local computing devices, the plurality of global ML models. The operations further comprise receive from each of the corresponding local computing device of the identified set of local computing devices either a selected ML model, or a gradient of the corresponding local computing device. The operations further comprise train the plurality of global ML models using the selected ML model, or the gradient of the corresponding local computing device received from each of the corresponding local computing device of the identified set of local computing devices.

According to a fifth aspect of embodiments herein a computer-readable medium is provided, comprising instructions which when executed on a computer, cause the computer to perform the method of any one of the embodiments of the first aspect.

According to a sixth aspect of embodiments herein a computer-readable medium is provided, comprising instructions which when executed on a computer, cause the computer to perform the method of any one of the embodiments of the second aspect.

Certain embodiments may provide one or more of the following technical advantage(s). Increased ML performance, including in non-IID settings, for collaborative machine learning models such as FL and Iterative Federated Clustering Algorithm (IFCA) may be achieved by adaptively learning expert models for use in a MoE, improving convergence, and/or priming these expert models so that clients make better estimates of cluster identity.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is an illustration of a communications network environment illustrating devices that may perform tasks of a local computing device and a server/global computing device according to some embodiments of the present disclosure;

FIG. 2 is a block diagram of an example ML models of a local computing device;

FIG. 3 is a sequence diagram illustrating an example embodiment for training a computer-implemented method for selecting a global ML model for collaborative machine learning in a communication network in accordance with various embodiments of the present disclosure;

FIG. 4 is a block diagram of a local computing device in accordance with some embodiments of the present disclosure;

FIG. 5 is a block diagram of a server/global computing device in accordance with some embodiments of the present disclosure;

FIGS. 6 and 7 are flow charts of operations of a local computing device in accordance with some embodiments of the present disclosure;

FIGS. 8 and 9 are flow charts of operations of a server/global computing device in accordance with some embodiments of the present disclosure;

FIG. 10 is a block diagram of a communication system in accordance with some embodiments of the present disclosure;

FIG. 11 is a block diagram of a user equipment in accordance with some embodiments of the present disclosure;

FIG. 12 is a block diagram of a network node in accordance with some embodiments of the present disclosure;

FIG. 13 is a block diagram of a host computer communicating with a user equipment in accordance with some embodiments of the present disclosure;

FIG. 14 is a block diagram of a virtualization environment in accordance with some embodiments of the present disclosure; and

FIG. 15 is a block diagram of a host computer communicating via a base station with a user equipment over a partially wireless connection in accordance with some embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter. Various embodiments of the present disclosure are described with reference to a distributed and decentralized ML setting that includes K clients. Each client has access to a local data partition.

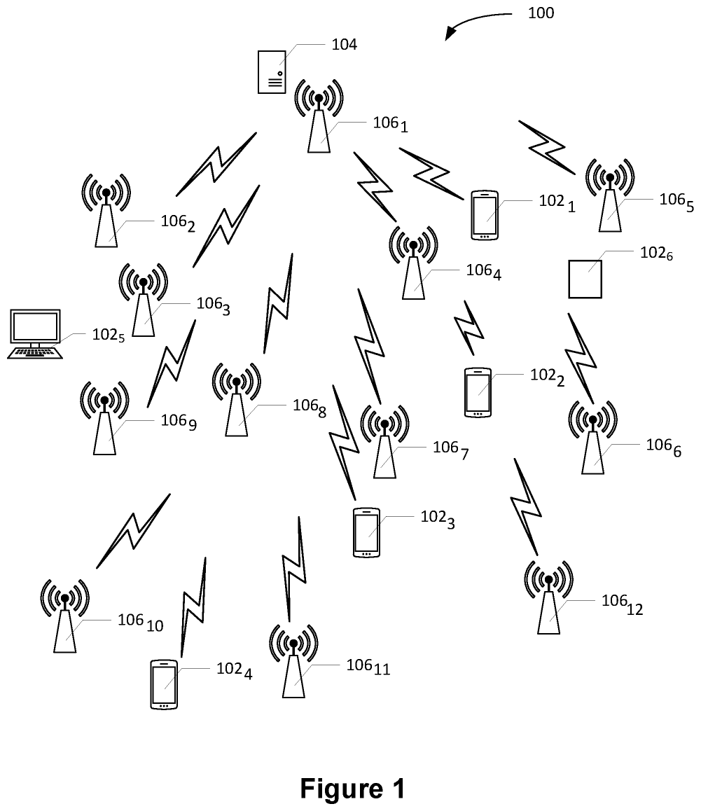

Some embodiments are described in the context of considering a multi-class classification problem where there are a number of measured data samples and output class labels is in a finite set. Each client partition of data is further divided into a set of training data and a local test set of data. The method of some embodiments concerns performance on the local test set in a non-IID setting. FIG. 1 is a diagram illustrating an example communications network 100 illustrating devices that may perform tasks of a computing device and a server according to some embodiments of the present disclosure. In FIG. 1, communications network 100 includes local computing devices 102₁ to 102₆ (such as mobile devices 102₁-102₅ or a network function(s) (NFs) 102₆, etc.) and global computing devices or servers 104, 106 (such as a core network node 104 or base stations 106₁-106₁₂, etc.). The communication network can include, without limitation, a cloud native network (e.g., an Open Radio Access Network (O-RAN)), and/or cloud native clients and/or servers (such as network functions (NFs) as clients and a network data analytics function (NWDAF) as a server, etc.).

Clustered FL will now be discussed. In many real distributed use-cases, data is naturally non-IID and clients in such use-cases form clusters of similar clients. A possible improvement over Federated Averaging (FedAvg) is to introduce global cluster ML models, but the problem of identifying these clusters remains. Clustered FL aims to find a cluster (that is, a subset of the population of clients) that benefit more from training together within the subset, as opposed to training with the population.

Using a FL approach described in Ghosh, A., Chung, J., Yin, D., and Ramchandran, K., An efficient framework for clustered federated learning. In Advances in Neural Information Processing Systems 33: Annual Conference on Neural Information Processing Systems 2020, NeurIPS 2020, Dec. 6-12, 2020, virtual, 2020, a largest number of expected clusters can be set to be J and one global ML model per cluster can be initialized. In a communication round having time t, each selected client can perform a cluster identity estimation, where it selects the global ML model that has the lowest estimated loss on the local training set. The global ML models can then be updated by using only gradients from the clients that selected each global ML model.

Another approach may be to use FL using a MoE. In order to construct a personalized ML model for each client, a local expert ML model can be added that is trained only on local data. A gating ML model can be defined to learn to weight the local ML model and the global ML model. In this way, personalization can be performed, even when a client's data is different from the data of the population.

Various embodiments of the present disclosure include a computer-implemented method performed by a computing device (e.g., local computing device 102) for selecting a global ML model from a plurality of global ML models using an epsilon greedy exploration process for collaborative machine learning in a communication network.

Potential advantages provided by various embodiments of the present disclosure may include that, by including an epsilon greedy exploration process, convergence of the global ML models may be improved. The method may artificially increase the chance that a global ML model is selected by the epsilon greedy exploration process. This also may allow global ML models to use more gradients of clients that improve performance of the selected global cluster ML model. An additional potential advantage of including the epsilon greedy exploration process may be that clients may use the global ML models to better estimate a cluster identity, leading to improved ML performance and in turn improved system performance.

As discussed further below, various embodiments of the present disclosure may improve adaptiveness of the global ML models by weighing exploration and exploitation of global ML models (e.g., by increasing convergence rate), as described further herein with reference to an epsilon greedy exploration process. An example embodiment of an epsilon greedy exploration process in discussed further herein with reference to “process 3”. Some embodiments include a way of changing the exploration and exploitation overtime; and some embodiments include a way of priming global ML models that may make the cluster identity estimation in clients better.

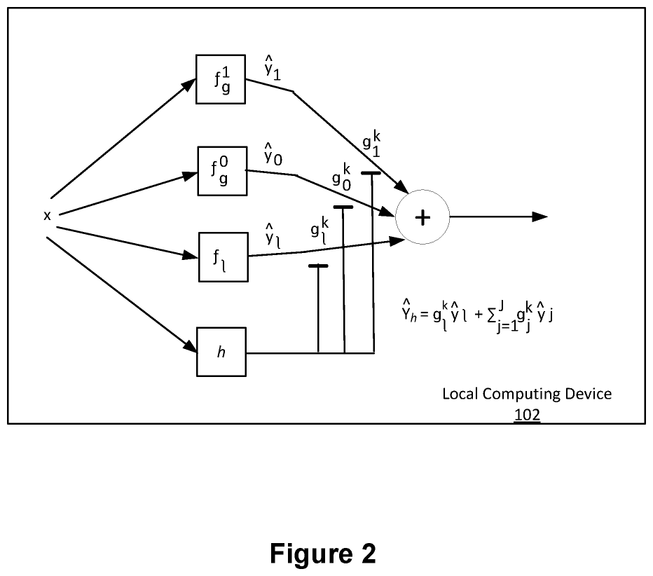

FIG. 2 is a block diagram of an example of ML models of a computing device referred to in this example as client k (e.g., local computing device 102). The ML models include a local expert ML model fₗ(wₗ^{k}) and J expert global ML models f_{g}^{j}w_{g}^{j} shared with other clients, where fₗ is the local expert ML model, wₗ^{k} are local ML model weights for client k, J is the number of global ML models, and f_{g}^{j}w_{g}^{j} are the global ML model with index j and the global ML model j weights, respectively. The client k uses a gating ML model h(wₕ^{k}) to weight the ML expert models and produce a personalized inference ŷh, where h is a gating model, wₕ^{k} are gating model weights for client k, and ŷh is the estimated target (gating). The gating ML model is a ML model (e.g., a neural network) that learns to weigh the output of the other ML models. As input, it takes a sample of data x (e.g., an image, or a few words typed on a mobile keyboard) and tries to give a high weight to the ML expert model that the gating ML model determines will perform best on this sample. In FIG. 2, these weights are the g's on the “arms” and in the equation.

In some embodiments of the present disclosure, in each communication round, a server (e.g., a global computing device 104) selects a set of clients or local computing devices 102 as described further herein with reference to “process 1”. In another process, (e.g., “process 2” described herein), each client or local computing device 102 will receive a plurality of global ML models; and using an epsilon greedy process (e.g., process 3 described further below), evaluate a metric on a set of data of the local computing device (e.g., a loss on a training set of data). The evaluation includes (a) using a random number generator to generate a random number r; and (b) If r<epsilon (where epsilon is a predetermined float), select a random global cluster ML model from the received plurality of global ML models, otherwise select the global ML model with the greatest performance on the set of data (e.g., the lowest loss on the local training dataset) from the received plurality of global ML models.

In some embodiments of the present disclosure, in each communication round, a server (e.g., a global computing device 104) selects a set of clients or local computing devices 102 (see e.g., process 1 described herein). In another process (e.g., process 2), each client or local computing device 102 will: receive a plurality of global ML models; and using an epsilon greedy with decay process (e.g., process 3 described further below), evaluate a metric on a set of data of the local computing device (e.g., a loss on a training set of data). The evaluation includes (a) using a random number generator to generate a random number r; and (b) If r<epsilon/t, where epsilon is a predetermined float and t the time period of the communication round i.e., the time taken for the communication between the local computing device 102 and the server or global computing device 104, select a random global ML model from the received plurality of global ML models, otherwise select the global ML model with the greatest performance on the set of data (e.g., the lowest loss on the local training dataset) from the received plurality of global ML models.

In some embodiments of the present disclosure, in each communication round, a server (e.g., a global computing device 104) selects a set of clients or local computing devices 102 (see e.g., process 1 described herein). In another process, each client or local computing device 102 will (see e.g., process 2): receive a plurality of global ML models; and using an epsilon greedy with adjusted decay process (e.g., process 3 described further below), evaluate a metric on a set of data of the local computing device (e.g., a loss on a training set of data). The evaluation includes (a) using a random number generator to generate a random number r; and (b) If r<epsilon/(t\hat{ }b), where epsilon is a predetermined float, t is the time period of the communication round i.e., the time taken for the communication between the local computing device 102 and the server or global computing device 104, and J the number of clusters, select a random global ML model from the received plurality of global ML models, otherwise select the global ML model with the greatest performance on the set of data (e.g., the lowest loss on the local training dataset) from the received plurality of global ML models. b can be, for example, dependent on the number of clusters, for example, b=2/J, where J is the number of clusters. b can also be a hyperparameter that is tuned. For example, the global ML model can be, without limitation, a convolutional neural network (CNN) model. Hyperparameters of the CNN model can be tuned, e.g., the number of filters in a number of convolutional layers, the number of hidden units in a fully connected layer, dropout, weight decay, etc. For the epsilon greedy process, the E-greedy parameter (E) can also be tuned.

While some of the embodiments discussed above are explained in the non-limiting context of evaluating a loss on a training set of data, the disclosure is not so limited. Instead, other metrics and data may be used, including without limitation, accuracy as a metric and evaluate on a validation set or test set of data.

In some embodiments, further operations include performing one or more training rounds on the set of data (e.g., the local training data), using the selected global ML model as a starting point.

In some embodiments, further operations include submitting the new ML model or gradients to the global computing device 104 wherein the new ML model is the global ML model selected based on the evaluation of the metric.

In other embodiments, in each communication round, a server (e.g., a global computing device 104) selects a set of clients or local computing devices 102 (see process 1 described herein). Each client will in process 2 described herein: receive a plurality of global ML models; and using process 3 described further below, evaluate loss on the respective training sets of data for a time t that is less than a time Tₑ for the maximum number of communication rounds, i.e., Tₑ is the time taken for the total number of rounds of communication between the local computing device 102 and the server or global computing device 104, to perform epsilon-greedy exploration (that is t<Tₑ). The maximum number of rounds is The evaluation includes (a) using a random number generator to generate a random number r; and (b) If r<epsilon (where epsilon is a predetermined float), select a random global ML model from the received plurality of global ML models, otherwise select the global ML model with the lowest loss on the local training dataset from the received plurality of global ML models.

In some embodiments, further operations include performing one or more training rounds on the set of data (e.g., the local training data), using the selected global ML model as a starting point at each client or local computing device 102.

In some embodiments, further operations include submitting the new ML model or gradients to the global computing device 104 wherein the new ML model is the global ML model selected based on the evaluation of the metric and the new ML model may be trained on the set of data.

In other embodiments, in each communication round, a server (e.g., a global computing device 104) selects a set of clients or local computing devices 102 (see process 1 described herein). Each client will in process 2 described herein: receive a plurality of global ML models; and using process 3 described further below, evaluate loss on the respective training sets of data as described in any of the above embodiments. Accordingly based on the loss evaluation either a random global ML model or a global ML model with the lowest loss on the local training dataset from the received plurality of global ML models is selected.

In these embodiments, the operations further include performing one or more training rounds on the set of data (e.g., the local training data), using either the selected global ML model or the randomly selected global ML model as a starting point.

In some embodiments, further operations include submitting the new ML model or gradients to the global computing device 104 wherein the new ML model is either the random global ML model or a global ML model with the lowest loss on the local training dataset and the new ML model may be trained on the set of data.

Process 1, discussed above, includes an algorithm performed by a server (e.g., a global computing device 104) for clustered federated averaging with MoE. Process 1 can include the following example algorithm:

Algorithm 1: Clustered Federated Averaging with Mixture of Experts-server

| 1: | procedure SERVER (C, K) | |
|---|---|---|
| 2: | initialize {w_{g}^{j} (0) \|j ∈ {1, 2, . . . , J} } | [symbol] Initialize global cluster ML models |
| 3: | Kₛ = └CK┘ | [symbol] Number of clients to select |
| 4: | for t ∈ {1, 2, . . . } do | [symbol] Until convergence |
| 5: | Sₜ ⊆ {1, 2, . . ., K}, \|Sₜ\| = Kₛ | [symbol] Client selection-random sampling |

of Kₛ clients

| | | |
|---|---|---|
| 6: | for all k ∈ Sₜ do | [symbol] For all clients, in parallel |
| 7: | w^{k} (t + 1), n^{k}, Ĵ^{k} ← k.CLIENT ({w_{g}^{j} \| j ∈ {1, 2, . . ., J} } ) | [symbol] Local |

training

| 8: | for all j ∈ {1, 2, . . ., J} do | [symbol] For all global cluster models |
|---|---|---|
| 9: | n^{j} ← [symbol] | [symbol] Total number of samples for global |
| | cluster model j from clients where j = Ĵ | |
| 10: | ${w}_{g}^{j} ( t + 1 ) ← {\sum }_{k ∈ \{ {S}_{t} \vert {\hat{J}}^{k} = j \}} \frac{{n}^{k}}{{n}^{j}} {w}^{k} ( t + 1 )$ | [symbol] Update global cluster model j |

with clients where j = Ĵ

Process 2, discussed above, includes an algorithm performed by a client (e.g., a local computing device 102) for clustered federated averaging with MoE. Process 2 can include the following example algorithm:

Algorithm 2: Clustered Federated Averaging
with Mixture of Experts - client

11: procedure CLIENT ({ w_{g}^{j} | j ∈ {1, 2, . . ., J} } )
12: n^{k} = |ρ^{k}| [symbol] Number of data samples for this client
13: ĵ ← CL.-EST. (k, t, ε, {w_{g}^{j} | j ∈ {1, 2, . . ., J} } )
14: w^{k} (t+1) ← UPDATE (w_{g}^{ĵ} (t), n^{k}
15: return (w^{k} (t + 1), n^{k}, ĵ)

Process 3, discussed above, includes an algorithm performed by a client (e.g., a local computing device 102) for clustered federated averaging with MoE—cluster assignment. Process 3 can include the following example algorithm:

Algorithm 3: Clustered Federated Averaging with Mixture of Experts-cluster assignment

| 15: | procedure CL.-EST. (k, t, ε, {w_{g}^{j} \| j ∈ {1, 2, . . . , J} } ) | |
|---|---|---|
| 16: | $\hat{J} ← \{ \begin{matrix}{argmin}_{j ∈ \{ 1 , 2 , … , J \}} {f}_{g} ( {w}_{g}^{j} ) & with probaility 1 - ε \\ 𝒰 \{ 1 , J \} & with probability ε\end{matrix}$ | [symbol] Lowest loss cluster [symbol] Random assignment |
| 17: | return Ĵ | [symbol] return cluster assignment |

Operations discussed above for submitting the new ML model or gradients to the server (e.g., a global computing device 104) can be performed in another process, referred to herein as “process 4”. Process 4 can include an algorithm performed by a client (e.g., a local computing device 102) for clustered federated averaging with MoE—client local update. Process 4 can include the following example algorithm:

Algorithm 4: Clustered Federated with Mixture of Experts-client local update

| 18: | procedure UPDATE (w^{k} (t), n^{k} | [symbol] Mini-batch gradient descent |
|---|---|---|
| 19: | w^{k} (t + 1) ← w^{k} (t) | |
| 20: | for e ∈ {1, 2, . . ., E} do | [symbol] For a few epochs |
| 21: | for all batches of size B do | [symbol] Batch update |

| | |
|---|---|
| 22: | ${w}^{k} ( t + 1 ) ← {w}^{k} ( t + y ) - \frac{n}{B} {▽}_{w} {k}_{( t + 1 )} {\sum }_{i = 1}^{B} {l}_{i} ( {x}_{i} , {y}_{i} , {w}^{k} ( t + 1 ) )$ |
| 23: | return w^{k} (t + 1) |

Symbols used herein, including in Algorithms 1-4 above, refer to:
B Batch size
C Fraction of clients selected
E local epochs
ε ε-greedy parameter
[symbol] Learning rate
\hat{f} Estimated
f_{g}^{j} Global ML model with index j
f_{g} Global ML model
fₗ Local ML model
fₗ^{k} Local ML model for client k
fₗ^{k′} Local ML model for client k′
gⱼ^{k} Gate ML model weight for cluster ML model j and client k
gₗ^{k} Gate ML model weight for local ML model
gₗ Gate ML model weight for local ML model for client k
h Gate ML model function
h^{k} Gate ML model for client k
J Number of cluster models
j Cluster ML model index
ĵ Cluster ML model identity estimate
K Number of clients
k Client index
k′ Client index, primed
Kₛ Number of selected clients
l Loss function
n number of data samples
n^{j} Total number of samples for cluster model j from clients
n^{k} Total number of samples for client k
P Probability
p majority class fraction
p^{k} Partition of dataset accessible to client k
{1, 2, . . . , K} Population of clients
Sₜ Selected set of clients at time t
t time in communication rounds
w ML model weights
w_{g} Global ML model weights
w_{g}^{j} Global ML model j weights
w_{g}^{ĵ} (t) Global ML model j weights at time t
w_{g}^{k} (0) Global ML model j weights at time 0
w_{g}^{j} (t+1) Global ML model j weights at time t+1
wₕ^{k} Gating ML model weight for client k
w^{k}(t) Global ML model weights for global ML model at time t
wₗ Local ML model weights
w^{k} (t+1) Global ML model weights from global ML model at time t+1
x Features of data sample
xᵢ Features of data sample i
y Target of data sample
ŷ_{y} Estimated target (gating)
ŷₕ Estimated target (gating)
ŷⱼ Estimated target (global cluster)
ŷₗ Estimated target (local)yᵢ Target of data sample

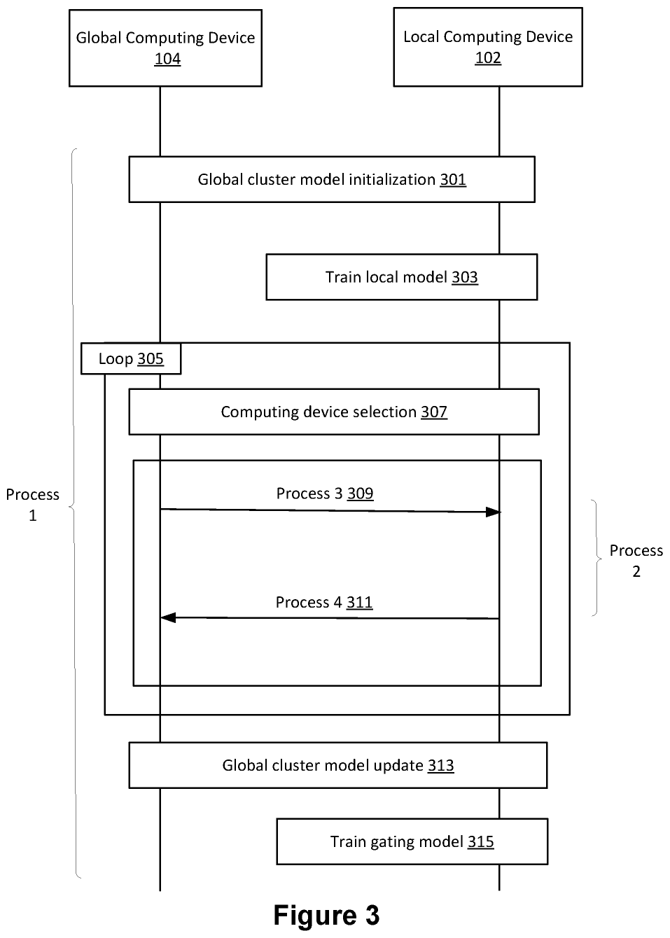

FIG. 3 is a sequence diagram illustrating an example embodiment for training a computer-implemented method for selecting a global ML model in accordance with various embodiment of the present disclosure. FIG. 3 includes a server (e.g., global computing device 104) and a computing device (e.g., local computing device 102). At operation 301, global ML model initialization is performed at server 104 and computing device 102. In operation 303, computing device 102 trains a local ML model. Loop 305 includes operations 307, 309, and 311, which occur in iterative communication rounds between computing device 102 and server 104 (e.g., as described herein with reference to process 1, process 2, process 3 and process 4). In operation 307, server 104 selects computing device 102. Process 3 is performed in operation 309, and server 104 signals a cluster assignment i.e., a plurality of global ML models to computing device 102. In operation 311, computing device 102 performs process 4 and signals a local update for a selected global ML model to server 104. The selected global ML model is updated in operation 313. In operation 315, computing device 102 trains a gating ML model to select between selected global ML models resulting from iterations of loop 305. The gating ML model is an ML model that takes the same input x and outputs a (softmax) weight for each of the expert models.

Various embodiments of the present disclosure are applicable to many decentralized and distributed ML use cases, such as secondary carrier prediction, antenna tilt optimization or improvement, etc.; as well as to Internet of Things (IoT) use cases and radio access network (RAN) use cases.

In one example, the method of various embodiments is used in connection with next word prediction. Next word prediction is used in many mobile phone applications and keyboards to predict what word a user wants to type next. Words can of course be very personal and privacy sensitive, so FL can be applied in this use-case. However, users and their mobile phones are geographically distributed, and have different languages, and use language differently. Finding similar users may have the advantage of making next word prediction much more accurate. Data here is non-IID in many different ways, and this can be a difficult problem. For example, American English and British English have many similarities between the two, but also differences. These two variations of English can train together in a cluster, but possibly together with Australian English, Indian English etc. The method of various embodiments of the present disclosure may more efficiently discover such language clusters.

In another example, the method of various embodiments is used in connection with secondary carrier prediction. A method to configure a user device with one or more ML models for executing radio networking operations is provided which can enable less signaling in comparison to use cases where the ML model input is located at the device side. One such use case is the secondary carrier prediction use case. In order to detect a node on another frequency using target carrier prediction, one approach requires the user equipment (UE) to perform signaling of source carrier information, where a mobile UE periodically transmits source carrier information to enable the macro node to handover the UE to another node operating at a higher frequency. Using target carrier prediction, the UE does not need to perform inter-frequency measurements, leading to energy savings at the UE. However, frequent signaling of source carrier information that enables prediction of the secondary frequency can lead to an additional overhead and should thus be minimized. The risk of not performing frequent periodic signaling is missing an opportunity of doing an inter-frequency handover to a less-loaded cell on another carrier. The UE can instead receive the ML model and use source carrier information as input to the model, which then triggers an output indicating coverage on another frequency node at location 2. This may reduce the need of frequent source carrier information signaling, while enabling the UE to predict the coverage on frequency 2 whenever its model input changes. Since the cells in the network are geographically distributed by nature, data generated in these cells have non-IID characteristics. Finding similar cells with the method of various embodiment of the present disclosure may have the benefit of allowing fewer ML models to be, with greater or improved performance.

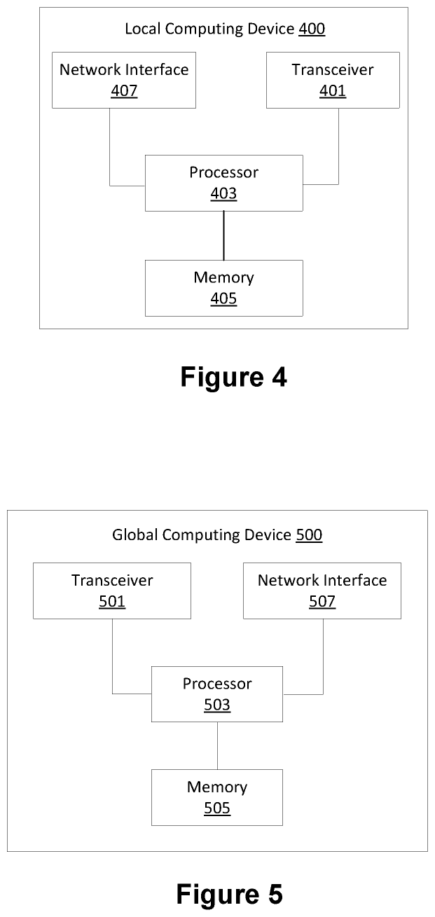

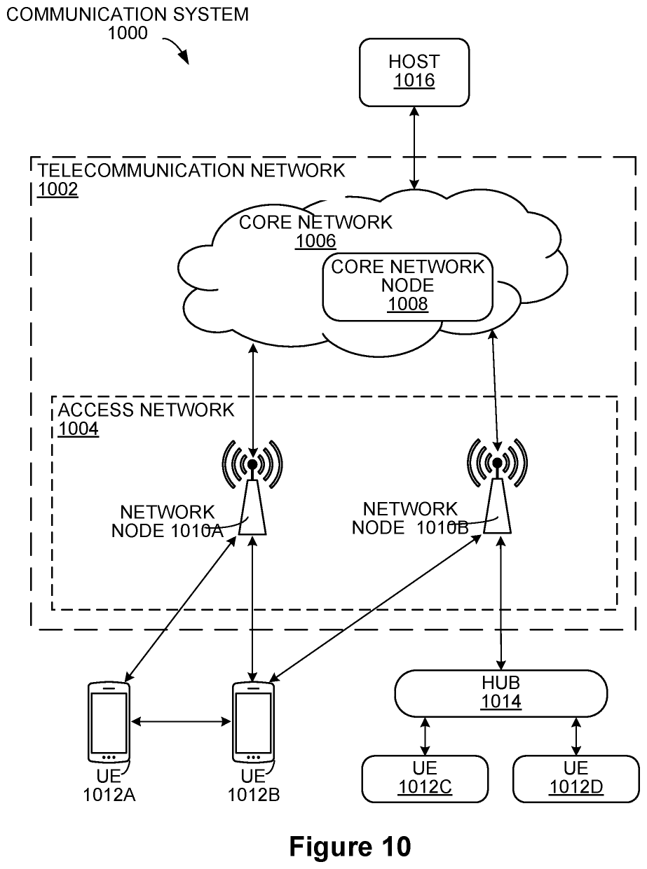

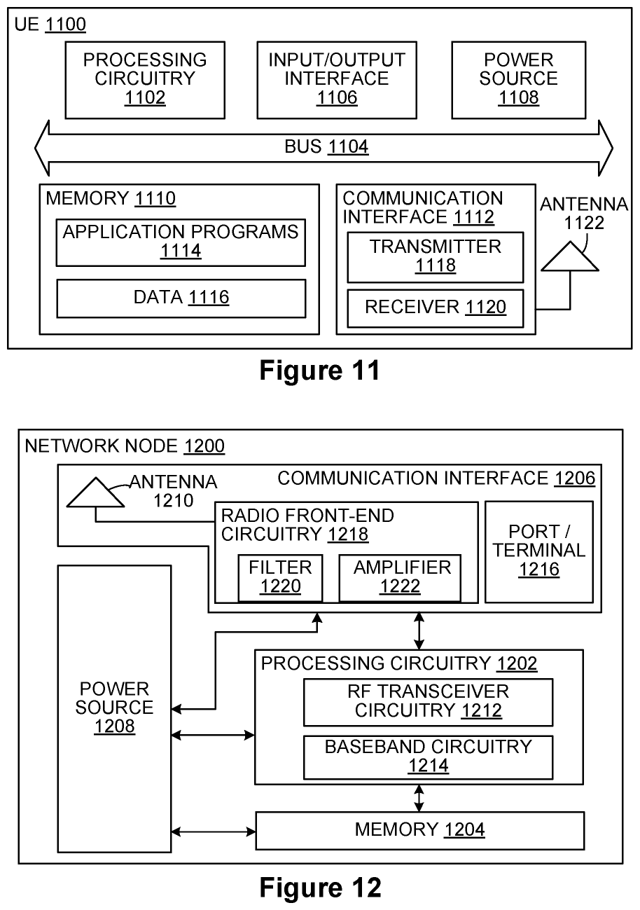

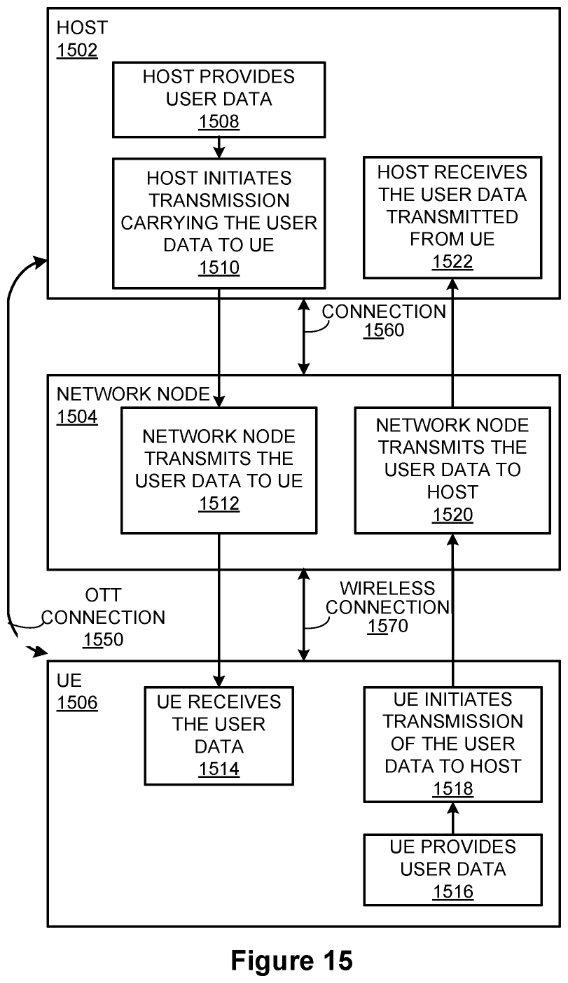

FIG. 4 is a block diagram illustrating elements of a local computing device 400 (also referred to as a mobile terminal, a mobile communication terminal, a wireless device, a wireless communication device, a wireless terminal, mobile device, a wireless communication terminal, user equipment, UE, a user equipment node/terminal/device, a computer, etc.) configured to provide operations according to embodiments of inventive concepts. (Computing device 400 may be provided, for example, as discussed below with respect to wireless devices UE 1012A, UE 1012B, and wired or wireless devices UE 1012C, UE 1012D of FIG. 10, UE 1100 of FIG. 11, virtualization hardware 1404 and virtual machines 1408A, 1408B of FIG. 14, and UE 1506 of FIG. 15, all of which should be considered interchangeable in the examples and embodiments described herein and be within the intended scope of this disclosure, unless otherwise noted.) As shown, local computing device may include transceiver circuitry 401 (also referred to as a transceiver, e.g., corresponding to interface 1112 of FIG. 11 having transmitter 1118 and receiver 1120) including a transmitter and a receiver configured to provide uplink and downlink radio communications with a base station(s) (e.g., corresponding to network node 1010A, 1010B of FIG. 10, network node 1200 of FIG. 12, and network node 1504 of FIG. 15 also referred to as a RAN node) of a communication network (e.g., radio access network). As shown, local computing device may include a network interface 407 for enabling network connectivity. Local computing device may also include processing circuitry 403 (also referred to as a processor, e.g., corresponding to processing circuitry 1102 of FIG. 11, and control system 1412 of FIG. 14) coupled to the transceiver circuitry, and memory circuitry 405 (also referred to as memory, e.g., corresponding to memory 1110 of FIG. 10) coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that separate memory circuitry is not required. Local computing device may also include an interface (such as a user interface) coupled with processing circuitry 403, and/or local computing device may be incorporated in a vehicle.

As discussed herein, operations of local computing device may be performed by processing circuitry 403 and/or transceiver circuitry 401. For example, processing circuitry 403 may control transceiver circuitry 401 to transmit communications through transceiver circuitry 401 over a radio interface to a communication network (e.g., a radio access network node (also referred to as a base station)) and/or to receive communications through transceiver circuitry 401 from a communication network (e.g., a RAN node over a radio interface). Moreover, modules may be stored in memory circuitry 405, and these modules may provide instructions so that when instructions of a module are executed by processing circuitry 403, processing circuitry 403 performs respective operations (e.g., operations discussed below with respect to example embodiments relating to computing devices). According to some embodiments, a local computing device 400 and/or an element(s)/function(s) thereof may be embodied as a virtual node/nodes and/or a virtual machine/machines.

FIG. 5 is a block diagram illustrating elements of a server or a global computing device 500 (also referred to as a NWDAF, etc.) of a communication network configured to provide operations according to embodiments of inventive concepts. (Server 500 may be provided, for example, as discussed below with respect to network node 1010A, 1010B of FIG. 10, network node 1200 of FIG. 3, core network node 1008 of FIG. 10, hardware 1404 or virtual machine 1408A, 1408B of FIG. 14, hardware 1404 or virtual machine 1408A, 1408B of FIG. 14, and/or base station 1504 of FIG. 15, all of which should be considered interchangeable in the examples and embodiments described herein and be within the intended scope of this disclosure, unless otherwise noted.) As shown, the server or global computing device may include transceiver circuitry 501 (also referred to as a transceiver, e.g., corresponding to portions of RF transceiver circuitry 1212 and radio front end circuitry 1218 of FIG. 12) including a transmitter and a receiver configured to provide uplink and downlink radio communications with mobile terminals. The server or global computing device may include network interface circuitry 507 (also referred to as a network interface, e.g., corresponding to portions of communication interface 1206 of FIG. 12) configured to provide communications with other nodes (e.g., with other servers or computing devices) of the communication network. The server or global computing device may also include processing circuitry 503 (also referred to as a processor, e.g., corresponding to processing circuitry 1202 of FIG. 12) coupled to the transceiver circuitry, and memory circuitry 505 (also referred to as memory, e.g., corresponding to memory 1204 of FIG. 12) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the server or global computing device may be performed by processing circuitry 503, network interface 507, and/or transceiver 501. For example, processing circuitry 503 may control transceiver 501 to transmit downlink communications through transceiver 501 over a radio interface to one or more servers or computing devices and/or to receive uplink communications through transceiver 501 from one or more servers or computing devices over a radio interface. Similarly, processing circuitry 503 may control network interface 507 to transmit communications through network interface 507 to one or more other servers or computing devices and/or to receive communications through network interface from one or more other computing devices or servers. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to servers). According to some embodiments, server or global computing device 500 and/or an element(s)/function(s) thereof may be embodied as a virtual node/nodes and/or a virtual machine/machines.

According to some other embodiments, a server or global computing device may be implemented as a core network (CN) node without a transceiver. In such embodiments, transmission to a wireless computing device may be initiated by the server so that transmission to the wireless computing device is provided through a network node including a transceiver (e.g., through a base station or RAN node). According to embodiments where the server is a RAN node including a transceiver, initiating transmission may include transmitting through the transceiver.

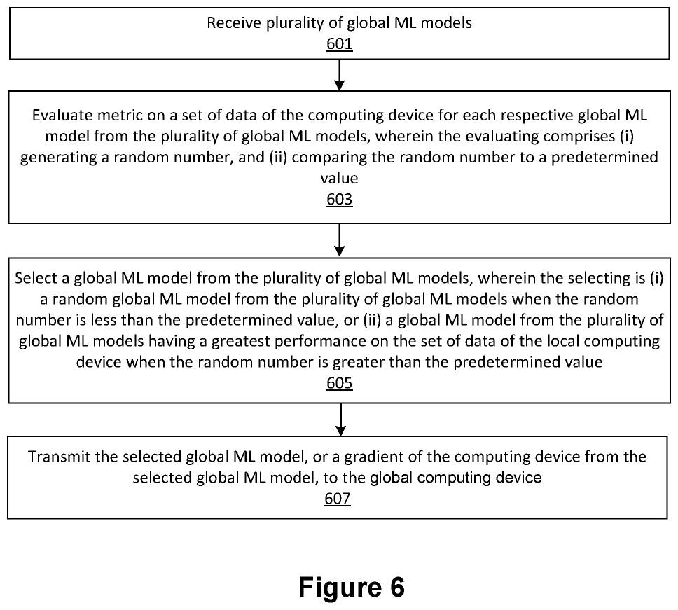

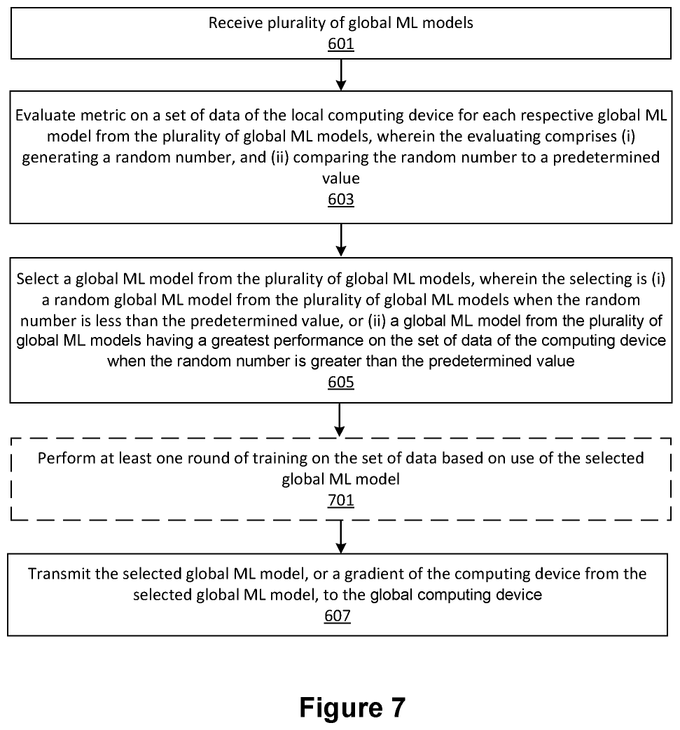

In the description that follows, while the local computing device may be any of the computing device 400, wireless device 1012A, 1012B, wired or wireless devices UE 1012C, UE 1012D, UE 1100, virtualization hardware 1404, virtual machines 1408A, 1408B, or UE 1506, the local computing device 102 shall be used to describe the functionality of the operations of the local computing device. Operations of the local computing device 102 (implemented using the structure of the block diagram of FIG. 4) will now be discussed with reference to the flow charts of FIGS. 6 and 7 according to some embodiments of inventive concepts. For example, modules may be stored in memory 405 of FIG. 4, and these modules may provide instructions so that when the instructions of a module are executed by respective computing device processing circuitry 403, processing circuitry 403 performs respective operations of the flow charts.

Referring first to FIG. 6, a computer-implemented method performed by a local computing device (102, 400) for selecting a global machine learning (ML) model for collaborative machine learning in a communication network is provided. The method comprises receiving (601), from a server, a plurality of global ML models. The method further comprises evaluating (603) a metric on a set of data of the local computing device for each respective global ML model from the plurality of global ML models. The evaluating comprises (i) generating a random number, and (ii) comparing the random number to a predetermined value. The method further comprises selecting (605) a global ML model from the plurality of global ML models. The selecting is (i) a random global ML model from the plurality of global ML models when the random number is less than the predetermined value, or (ii) when the random number is greater than the predetermined value, a global cluster ML model from the plurality of global cluster ML models having a greatest performance on the set of data of the local computing device when the random number is greater than the predetermined value. The method further comprises transmitting (607) the selected global ML model, or a gradient of the computing device from the selected global ML model to the global computing device (104).

In some embodiments, the communication network comprises a plurality of computing devices having non-independent and identically distributed, non-IID, data. In some embodiments, the predetermined value is a predetermined float value that varies over a time period set for the evaluating (603). In some embodiments, the predetermined value is a predetermined float value for a time period corresponding to a round of the evaluating (603) and is calculated by a function f that takes in J f(J), where J is a number of the plurality of global cluster ML models, or the predetermined float value is tuned off-line. In some embodiments, the evaluating (603) and the selecting (605) are performed for a time period, wherein the time period is an amount of time that is less than a defined maximum number of rounds of communication between the computing device and the server to perform the evaluating (603) and the selecting (605).

In some embodiments, the set of data is a set of training data, the metric is a loss on the set of training data, and the greatest performance is a lowest loss on the set of training data.

Referring now to FIG. 7, in some embodiments, the method further comprises performing (701) at least one round of training on the set of data based on use of the selected global ML model. In some embodiments, the evaluating (603) further comprises weighing exploration and exploitation of the plurality of global ML models to increase a convergence rate of the plurality of global ML models.

In some embodiments, the communication network is a radio access network, and the selected global ML model is a ML model for secondary carrier prediction for a cluster of cells in the radio access network. In some embodiments, the communication network is a radio access network, and the selected global ML model is a ML model for antenna tilt optimization or improvement prediction for a cluster of network nodes in the radio access network. In some embodiments, the selected global ML model is a ML model for next word prediction for a cluster of computing devices using a plurality of language variations.

Various operations from the flow chart of FIG. 7 may be optional with respect to some embodiments of a method performed by a local computing device. For example, operations of block 701 of FIG. 7 may be optional.

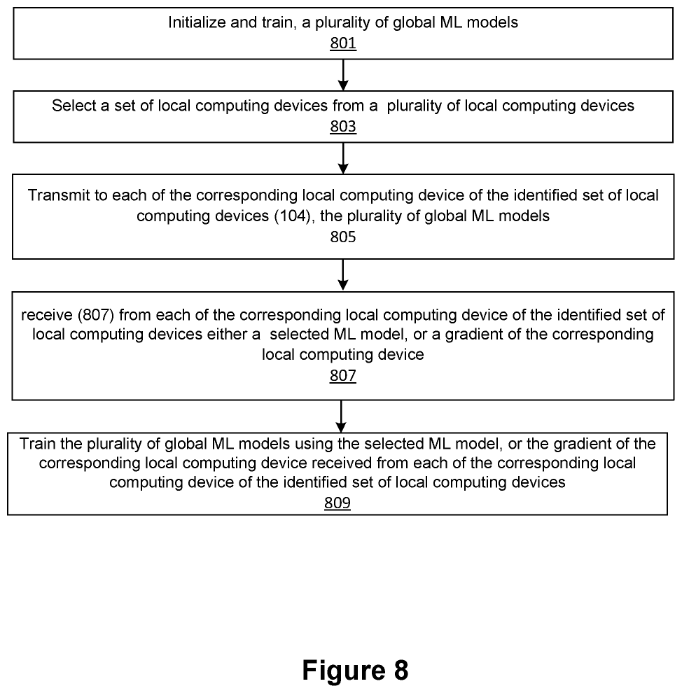

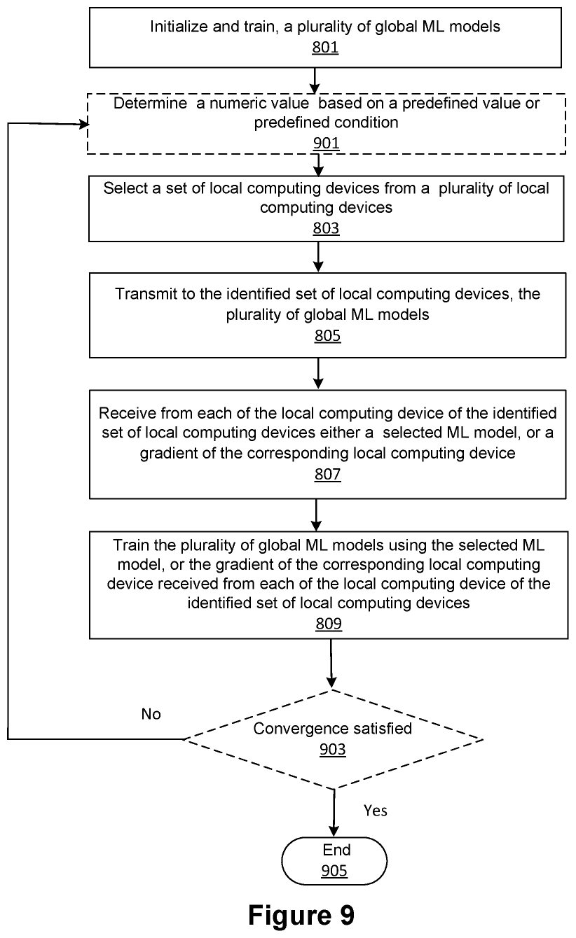

In the description that follows, while the global computing device or sever 104 may be any of the computing device 500, to network node 1010A, 1010B of FIG. 10, network node 1200 of FIG. 3, core network node 1008 of FIG. 10, hardware 1404 or virtual machine 1408A, 1408B of FIG. 14, hardware 1404 or virtual machine 1408A, 1408B of FIG. 14, and/or base station 1504 of FIG. 15, the global computing device 104 shall be used to describe the functionality of the operations of the server or global computing device. Operations of the global computing device 104 (implemented using the structure of the block diagram of FIG. 5) will now be discussed with reference to the flow charts of FIGS. 8 and 9 according to some embodiments of inventive concepts. For example, modules may be stored in memory 505 of FIG. 5, and these modules may provide instructions so that when the instructions of a module are executed by respective computing device processing circuitry 503, processing circuitry 503 performs respective operations of the flow charts.

Referring first to FIG. 8, a computer-implemented method performed by a global computing device 104 for collaborative machine learning (ML) in a communication network is provided. The method comprises initializing and training (801), a plurality of global ML models. The method further comprises selecting (803) a set of local computing devices from a plurality of computing devices wherein the set of local computing devices is selected either in an uniform or random manner from the plurality of computing devices. The method further comprises transmitting (805) to each of the corresponding local computing device of the identified set of local computing devices, the plurality of global ML models. The method further comprises receiving (807) from each of the corresponding local computing device of the identified set of local computing devices either a selected ML model, or a gradient of the corresponding local computing device. The method further comprises training (809) the plurality of global ML models using the selected ML model, or the gradient of the corresponding local computing device received from each of the corresponding local computing device of the identified set of local computing devices.

In some embodiments, the convergence condition satisfied comprises the plurality of global ML models attains a convergence rate. A ML model is considered to have converged when the performance (loss) of the ML model settles to within some error range from an optimal value, i.e., more training will not further improve the ML model.

Referring now to FIG. 9, in some embodiments, the method further comprises determining (901) a numeric value based on a predefined value or predefined condition wherein the numeric value is a positive integer number which denotes the number of local computing devices to be selected in the set of local computing devices.

In some embodiments, the method further comprises performing (903) the steps of selecting (803), transmitting (805), receiving (807) and training (809) repetitively until a convergence condition is satisfied.

Various operations from the flow chart of FIG. 9 may be optional with respect to some embodiments of a method performed by a global computing device or server. For example, operations of blocks 901 and 903 of FIG. 9 may be optional.

Although local computing device 400 and server or global computing device 500 are illustrated in the example block diagrams of FIGS. 4 and 5 each may represent a device that includes the illustrated combination of hardware components, other embodiments may comprise computing devices and servers with different combinations of components or network functions. It is to be understood that each of a local computing device and a server comprise any suitable combination of hardware and/or software needed to perform the tasks, features, functions and methods disclosed herein. Moreover, while the components of each of a local computing device and a server are depicted as single boxes located within a larger box, or nested within multiple boxes, in practice, each device may comprise multiple different physical components that make up a single illustrated component (e.g., a memory may comprise multiple separate hard drives as well as multiple RAM modules).

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010A and 1010B (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012A, 1012B, 1012C, and 1012D (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002 and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio—Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, fora UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012C and/or 1012D), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/orto another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010B. In other embodiments, the hub 1014 may be a non-dedicated hub—that is, a device which is capable of operating to route communications between the UEs and network node 1010B, but which is additionally capable of operating as a communication start and/or end point for certain data channels.

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-loT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V21), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-loT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

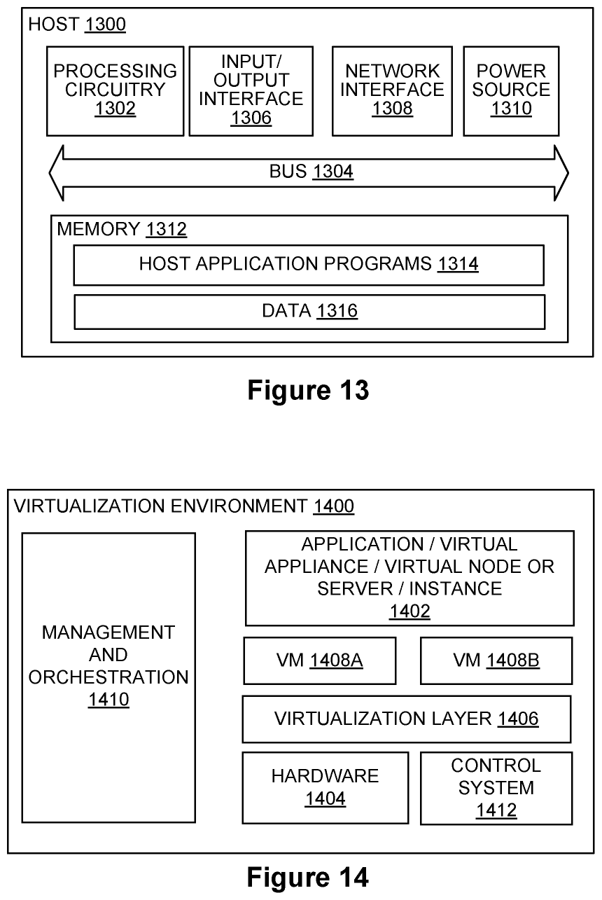

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment 1400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g., such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

FIG. 15 shows a communication diagram of a host 1502 communicating via a network node 1504 with a UE 1506 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 15.

Like host 1300, embodiments of host 1502 include hardware, such as a communication interface, processing circuitry, and memory. The host 1502 also includes software, which is stored in or accessible by the host 1502 and executable by the processing circuitry. The software includes a host application that may be operable to provide a service to a remote user, such as the UE 1506 connecting via an over-the-top (OTT) connection 1550 extending between the UE 1506 and host 1502. In providing the service to the remote user, a host application may provide user data which is transmitted using the OTT connection 1550.

The network node 1504 includes hardware enabling it to communicate with the host 1502 and UE 1506. The connection 1560 may be direct or pass through a core network (like core network 1006 of FIG. 10) and/or one or more other intermediate networks, such as one or more public, private, or hosted networks. For example, an intermediate network may be a backbone network or the Internet.

The UE 1506 includes hardware and software, which is stored in or accessible by UE 1506 and executable by the UE's processing circuitry. The software includes a client application, such as a web browser or operator-specific “app” that may be operable to provide a service to a human or non-human user via UE 1506 with the support of the host 1502. In the host 1502, an executing host application may communicate with the executing client application via the OTT connection 1550 terminating at the UE 1506 and host 1502. In providing the service to the user, the UE's client application may receive request data from the host's host application and provide user data in response to the request data. The OTT connection 1550 may transfer both the request data and the user data. The UE's client application may interact with the user to generate the user data that it provides to the host application through the OTT connection 1550.

The OTT connection 1550 may extend via a connection 1560 between the host 1502 and the network node 1504 and via a wireless connection 1570 between the network node 1504 and the UE 1506 to provide the connection between the host 1502 and the UE 1506. The connection 1560 and wireless connection 1570, over which the OTT connection 1550 may be provided, have been drawn abstractly to illustrate the communication between the host 1502 and the UE 1506 via the network node 1504, without explicit reference to any intermediary devices and the precise routing of messages via these devices.

As an example of transmitting data via the OTT connection 1550, in step 1508, the host 1502 provides user data, which may be performed by executing a host application. In some embodiments, the user data is associated with a particular human user interacting with the UE 1506. In other embodiments, the user data is associated with a UE 1506 that shares data with the host 1502 without explicit human interaction. In step 1510, the host 1502 initiates a transmission carrying the user data towards the UE 1506. The host 1502 may initiate the transmission responsive to a request transmitted by the UE 1506. The request may be caused by human interaction with the UE 1506 or by operation of the client application executing on the UE 1506. The transmission may pass via the network node 1504, in accordance with the teachings of the embodiments described throughout this disclosure. Accordingly, in step 1512, the network node 1504 transmits to the UE 1506 the user data that was carried in the transmission that the host 1502 initiated, in accordance with the teachings of the embodiments described throughout this disclosure. In step 1514, the UE 1506 receives the user data carried in the transmission, which may be performed by a client application executed on the UE 1506 associated with the host application executed by the host 1502.

In some examples, the UE 1506 executes a client application which provides user data to the host 1502. The user data may be provided in reaction or response to the data received from the host 1502. Accordingly, in step 1516, the UE 1506 may provide user data, which may be performed by executing the client application. In providing the user data, the client application may further consider user input received from the user via an input/output interface of the UE 1506. Regardless of the specific manner in which the user data was provided, the UE 1506 initiates, in step 1518, transmission of the user data towards the host 1502 via the network node 1504. In step 1520, in accordance with the teachings of the embodiments described throughout this disclosure, the network node 1504 receives user data from the UE 1506 and initiates transmission of the received user data towards the host 1502. In step 1522, the host 1502 receives the user data carried in the transmission initiated by the UE 1506.

One or more of the various embodiments improve the performance of OTT services provided to the UE 1506 using the OTT connection 1550, in which the wireless connection 1570 forms the last segment. More precisely, the teachings of these embodiments may improve data rates and latency and thereby provide benefits such as reduced user waiting time, improved content resolution, and better responsiveness.

In an example scenario, factory status information may be collected and analyzed by the host 1502. As another example, the host 1502 may process audio and video data which may have been retrieved from a UE for use in creating maps. As another example, the host 1502 may collect and analyze real-time data to assist in controlling vehicle congestion (e.g., controlling traffic lights). As another example, the host 1502 may store surveillance video uploaded by a UE. As another example, the host 1502 may store or control access to media content such as video, audio, VR or AR which it can broadcast, multicast or unicast to UEs. As other examples, the host 1502 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1550 between the host 1502 and UE 1506, in response to variations in the measurement results. The measurement procedure and/or the network functionality for reconfiguring the OTT connection may be implemented in software and hardware of the host 1502 and/or UE 1506. In some embodiments, sensors (not shown) may be deployed in or in association with other devices through which the OTT connection 1550 passes; the sensors may participate in the measurement procedure by supplying values of the monitored quantities exemplified above or supplying values of other physical quantities from which software may compute or estimate the monitored quantities. The reconfiguring of the OTT connection 1550 may include message format, retransmission settings, preferred routing etc.; the reconfiguring need not directly alter the operation of the network node 1504. Such procedures and functionalities may be known and practiced in the art. In certain embodiments, measurements may involve proprietary UE signaling that facilitates measurements of throughput, propagation times, latency and the like, by the host 1502. The measurements may be implemented in that software causes messages to be transmitted, in particular empty or ‘dummy’ messages, using the OTT connection 1550 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents and shall not be restricted or limited by the foregoing detailed description.

### REFERENCES

1. Ghosh, A., Chung, J., Yin, D., and Ramchandran, K. An efficient framework for clustered federated learning. In Advances in Neural Information Processing Systems 33: Annual Conference on Neural Information Processing Systems 2020, NeurIPS 2020, Dec. 6-12, 2020, virtual, 2020. URL https://proceedings. neurips.cc/paper/2020/hash/e32cc80bf07915058ce90722ee17bb71—Abstract.html

1-23. (canceled)

24. A computer-implemented method performed by a local computing device for collaborative machine learning (ML) in a communication network, the method comprising:
receiving, from a global computing device, a plurality of global ML models;
evaluating a metric on a set of data of the local computing device for each respective global ML model from the plurality of global ML models, wherein the evaluating comprises (i) generating a random number, and (ii) comparing the random number to a predetermined value;
selecting a global ML model from the plurality of global ML models, wherein the selecting is (i) a random global ML model from the plurality of global ML models when the random number is less than the predetermined value, or (ii) a global ML model from the plurality of global ML models having a greatest performance on the set of data of the local computing device when the random number is greater than the predetermined value; and
transmitting the selected global ML model, or a gradient of the computing device from the selected global ML model to the global computing device.

25. The method according to claim 24, wherein the predetermined value is a predetermined float value that varies over a time period.

26. The method according to claim 24, wherein the predetermined value is a predetermined float value for a time period corresponding to a round of the evaluating and is calculated by a function f that takes in J f(J), where J is a number of the plurality of global ML models, or the predetermined float value is tuned off-line.

27. The method according to claim 24, wherein the evaluating and the selecting are performed for a time period, wherein the time period is an amount of time that is less than a defined maximum number of rounds of communication between the computing device and the server to perform the evaluating and the selecting.

28. The method according to claim 24, wherein the communication network comprises a plurality of computing devices having non-independent and identically distributed, non-IID, data.

29. The method according to claim 24, wherein the set of data is a set of training data, wherein the metric is a loss on the set of training data, and wherein the greatest performance is a lowest loss on the set of training data.

30. The method according to claim 24, further comprising:
performing at least one round of training on the set of data using the selected global ML model.

31. The method according to claim 24, wherein the evaluating further comprises weighing exploration and exploitation of the plurality of global ML models to increase a convergence rate of the plurality of global ML models.

32. The method according to claim 24, wherein the communication network is a radio access network and the selected global ML model is a ML model for secondary carrier prediction for a cluster of cells in the radio access network.

33. The method according to claim 24, wherein the communication network is a radio access network and the selected global ML model is a ML model for antenna tilt optimization or improvement prediction for a cluster of network nodes in the radio access network.

34. The method according to claim 24, wherein the selected global ML model is a ML model for next word prediction for a cluster of local computing devices using a plurality of language variations.

35. A computer-implemented method performed by a global computing device for collaborative machine learning (ML) in a communication network, the method comprising:
initializing and training, a plurality of global ML models;
selecting a set of local computing devices from a plurality of computing devices;
transmitting to each of the corresponding local computing device of the identified set of local computing devices, the plurality of global ML models;
receiving from each of the corresponding local computing device of the identified set of local computing devices either a selected ML model, or a gradient of the corresponding local computing device; and
training the plurality of global ML models using the selected ML model, or the gradient of the corresponding local computing device received from each of the corresponding local computing device of the identified set of local computing devices.

36. The method according to claim 35, further comprising:
performing the steps of selecting, transmitting, receiving and training repetitively until a convergence condition is satisfied.

37. The method according to claim 35, further comprising:
determining a numeric value based on a predefined value or predefined condition wherein the numeric value a positive integer number which denotes the number of local computing devices to be selected in the set of local computing devices.

38. The method according to claim 37, wherein the convergence condition satisfied comprises the plurality of global ML models attains a convergence rate.

39. A local computing device for collaborative machine learning (ML) in a communication network, the local computing device comprising:
at least one processor;
at least one memory connected to the at least one processor and storing program code that is executed by the at least one processor to perform operations comprising:
receive, from a global computing device, a plurality of global ML models;
evaluate a metric on a set of data of the local computing device for each respective global ML model from the plurality of global ML models,
wherein the evaluate comprises (i) generate a random number, and (ii) compare the random number to a predetermined value;
select a global ML model from the plurality of global ML models, wherein the select is (i) a random global ML model from the plurality of global ML models when the random number is less than the predetermined value, or (ii) a global ML model from the plurality of global ML models having a greatest performance on the set of data of the computing device when the random number is greater than the predetermined value; and
transmit the selected global ML model, or a gradient of the local computing device from the selected global ML model, to the global computing device.

40. A global computing device for collaborative machine learning (ML) in a communication network, the global computing device comprising:
at least one processor;
at least one memory connected to the at least one processor (503) and storing program code that is executed by the at least one processor to perform operations comprising:
initialize and train, a plurality of global ML models;
select a set of local computing devices from a plurality of local computing devices;
transmit to each of the corresponding local computing device of the identified set of local computing devices, the plurality of global ML models;
receive from each of the corresponding local computing device of the identified set of local computing devices either a selected ML model, or a gradient of the corresponding local computing device; and
train the plurality of global ML models using the selected ML model, or the gradient of the corresponding local computing device received from each of the corresponding local computing device of the identified set of local computing devices.
